(19) United States
(12) Patent Application Publication
(10) Pub. No.: US 2026/0326281 A1
(43) Pub. Date: Oct. 22, 2026

(54) Hand-Held Power Tool and Method for Operating a Hand-Held Power Tool

(71) Applicant: Robert Bosch GmbH, Stuttgart (DE)

(72) Inventors: Heiko Roehm, Stuttgart (DE); Ina Tatzel, Stuttgart (DE); Jorge Marti Sola, Reutlingen (DE); Marcus Schuller, Dettenhausen (DE); Tobias Herr, Grafenau (DE)

(21) Appl. No.: 19/647,508

(22) Filed: Apr. 14, 2026

(30) Foreign Application Priority Data
Apr. 17, 2025 (DE) 10 2025 115 075.3

(51) Int. Cl. B25F 5/02

(52) U.S. Cl. CPC B25F 5/021

(57) ABSTRACT

A hand-held power tool including a human-machine interface (“HMI”). The HMI includes (i) a first control element for a first mode of operation of the hand-held power tool, (ii) a second control element for a second mode of operation of the hand-held power tool, and (iii) a stage indicator. The first mode of operation is activatable, adjustable through a plurality of stages, and deactivatable using the first control element. The second mode of operation is activatable and deactivatable using the second control element. The stage indicator is configured to display at least one stage of the plurality of stages for the first mode of operation.

This application claims priority under 35 U.S.C. § 119 to patent application no. DE 10 2025 115 075.3, filed on Apr. 17, 2025 in Germany, the disclosure of which is incorporated herein by reference in its entirety.

The disclosure relates to a hand-held power tool with a human-machine interface and a method for operating a hand-held power tool.

### BACKGROUND

Hand-held power tools with a human-machine interface and methods for operating hand-held power tools are known from the prior art.

### SUMMARY

The disclosure aims to provide an improved hand-held power tool and an improved method for operating a hand-held power tool. In particular, the object may be seen as providing a hand-held power tool and a method that provide increased usability and adjustment options.

The object is achieved by means of a hand-held power tool and a method for operating a hand-held power tool. Advantageous embodiments are specified in the dependent claims.

According to a first aspect, a hand-held power tool with a human-machine interface (HMI) is proposed. The hand-held power tool is operable in at least a first mode of operation and/or a second mode of operation, wherein the HMI comprises a first control element for the first mode of operation and a second control element for the second mode of operation. The first mode of operation is activatable, adjustable through a plurality of stages, and deactivatable, wherein the first mode of operation is activatable, adjustable, and deactivatable using the first control element. The second mode of operation is activatable and deactivatable using the second control element. The HMI comprises a stage indicator for indicating the plurality of adjustable stages for the first mode of operation.

A mode of operation can generally be understood as a device setting for a hand-held power tool. For example, a speed for the hand-held power tool may be understood as a mode of operation. For example, a so-called kickback function for the hand-held power tool may also be understood as a mode of operation.

A device setting that provides a variety of adjustment options may be understood as the first mode of operation. For example, a speed may have many different speed setting options, i.e., be adjustable through a plurality of stages. A second mode of operation may be understood to be a device setting, for which no staged adjustment options are provided. For example, no adjustment option is provided for a kickback function. A kickback function is activatable and deactivatable, and no different adjustable stages are provided. In other words, for a second mode of operation, the states of activated and deactivated are provided, and for the first mode of operation, in an activated state, it is additionally provided to make some type of fine adjustment, that is, an adjustment through a plurality of stages, for the mode of operation.

A visual display device for a hand-held power tool may be understood as a stage indicator. The stage indicator may be used to display a currently set stage for a first mode of operation to a user of the hand-held power tool. For example, a currently activated and set speed setting for operation of the hand-held power tool may be displayed via the stage indicator.

Thus, the technical advantage can be achieved of providing an improved hand-held power tool. In particular, the advantage can be achieved of providing increased user-friendliness and improved adjustment options for the hand-held power tool. For this purpose, the HMI comprises a first control element, a second control element, and a stage indicator. Using the first control element and the stage indicator, a first mode of operation can be activated and adjusted with regard to an adjustment option in the form of stages. The user can activate, adjust and deactivate the mode of operation with only one control element. Furthermore, the user is able to activate and deactivate a second mode of operation using a second control element. It is advantageous that a separate control element is available to the user for each mode of operation. This also makes it possible, for example, to activate two modes of operation simultaneously. Advantageously, using the hand-held power tool, improved adjustment capability for the modes of operation may be provided to the user.

In a further embodiment, activating and deactivating the modes of operation can be performed by actuating the respective associated control element, wherein activating and deactivating the modes of operation can be performed by actuating the respective associated control element for a defined period of time.

Thus, the technical advantage can be achieved of providing a further improvement to the hand-held power tool. By providing actuation for a defined time period for activation and deactivation, for example, accidental activation or deactivation of the modes of operation may be prevented.

In a further embodiment, adjusting the plurality of stages for the first mode of operation can be performed after activation and by re-actuating the associated first control element, wherein adjusting the stages can be performed by actuating the respective associated first control element multiple times within a specified period of time.

Thus, the technical advantage can be achieved of providing a particularly intuitive and efficiently operable hand-held power tool. In particular, actuating the same control element multiple times within a specified period of time enables the user to efficiently and conveniently adjust the plurality of stages for the first mode of operation without relying on additional control elements or complex menu navigation. This can reduce the complexity of the HMI on the one hand, while ensuring particularly fast and precise adjustment of the mode of operation on the other hand. Furthermore, this design allows a space-saving and manageable HMI, which is particularly advantageous for compact hand-held power tools.

In a further embodiment, the HMI comprises a further first control element for a further first mode of operation, wherein the further first mode of operation can be activated, adjusted through a plurality of stages, and deactivated using the further first control element. The stage indicator is configured to display the plurality of adjustable stages for the first mode of operation and the further first mode of operation.

This makes it possible to achieve the technical advantage of providing a hand-held power tool with a particularly manageable and versatile HMI, wherein the operability and range of functions of the hand-held power tool can be significantly improved. By providing a further first control element for a further first mode of operation, not only can the range of functions of the machine be expanded, but intuitive and ergonomic operation can also be achieved at the same time. The specific design of the stage indicator for the respective display of the adjustable stages for the first modes of operation also creates optimum manageability, thereby avoiding operating errors and ensuring a quick change between different operating states. As a result, this further development results in significantly improved operator safety, efficiency, and flexibility when using the hand-held power tool.

In a further embodiment, the HMI comprises a further second control element for a further second mode of operation, wherein the further second mode of operation is activatable and deactivatable using the further second control element.

This makes it possible to achieve the technical advantage of further increasing the flexibility and user-friendliness of the hand-held power tool. By separately activating and deactivating a further second mode of operation using a specifically provided further second control element, users can quickly and clearly switch between different functionalities of the hand-held power tool. This not only reduces the complexity of the HMI, but also avoids accidental misadjustments or improper operation. The clear assignment of a dedicated control element for the further second mode of operation also contributes to intuitive operability, which can increase ease of use for the user.

In a further embodiment, the control elements are additionally configured as display elements, wherein the control elements are designed to indicate to a user whether the mode of operation respectively assigned to the control elements is activated or deactivated, wherein the control elements are configured to be illuminable, and are provided in particular in the form of buttons.

This makes it possible to achieve the technical advantage that the user of the hand-held power tool can immediately detect, in a simple, intuitive, and reliable manner, whether a particular mode of operation is currently activated or deactivated. In particular, the configuration of the control elements as illuminated buttons allows for clear visual feedback that effectively avoids operating errors and ensures precise control of the device. At the same time, combining the control and display elements in one component leads to a manageable and compact design of the HMI, which significantly improves the handling of the hand-held power tool.

In a further embodiment, the stage indicator is configured as an LED bar in the form of a plurality of illuminable LED elements.

In a further embodiment, the stage indicator is configured in the form of a 7-segment display, in particular in the form of a two-digit 7-segment display.

This makes it possible to achieve the technical advantage that a particularly precise, exact, and clear indication of the currently set stage is provided to the user. In particular, by using a 7-segment display or an LED bar, a large number of adjustable stages can be displayed clearly and in a space-saving manner. This can improve operability and ensure fast, error-free correlation of the adjustable stages. At the same time, this embodiment offers the advantage of a particularly compact display, which makes the HMI overall more manageable and user-friendly.

In a further embodiment, the HMI comprises worksite lighting, wherein the worksite lighting can be activated and deactivated as the second mode of operation using the second control element.

This provides the technical advantage that the user is provided with a simple, fast, and intuitive way to selectively illuminate a work site. By being directly activated and deactivated via the second control element as an independent second mode of operation, the worksite lighting allows the user to react flexibly and appropriately to different lighting conditions. In addition, this design provides a convenient and function-integrated solution for the HMI, since no external lighting has to be provided.

In a further embodiment, the hand-held power tool is operable in a third mode of operation, wherein the third mode of operation can be activated and deactivated using the first control element and the second control element, and wherein the third mode of operation can be activated and deactivated by simultaneously actuating the first control element and the second control element for a defined period of time.

A particular setting for the HMI of the hand-held power tool may be understood as the third mode of operation. For example, a third mode of operation may be a lock function for the HMI. In other words, activation of the third mode of operation may enable the user to lock the HMI, i.e., not activate, adjust, or deactivate a first or second mode of operation. After deactivating the third mode of operation, the HMI is unlocked. In other words, in the unlocked state, the user is able to activate, adjust, or deactivate the first or second mode of operation.

This provides the technical advantage that an additional third mode of operation can be activated and deactivated simply, safely, and unambiguously without providing a separate additional control element. Specifically activating and deactivating the third mode of operation by simultaneously actuating the first and second control elements for defined time period reduces the scope of the user interface while also avoiding accidental or unintended actuations. This purposefully combined operation provides a clear, intuitive, and space-saving solution that can further improve the ergonomics and operational safety of the hand-held power tool.

According to a second aspect, a method for operating a hand-held power tool, in particular a hand-held power tool according to one of the preceding embodiments, is proposed, wherein the hand-held power tool comprises an HMI for operation by a user, wherein the HMI comprises at least a first control element for a first mode of operation, a second control element for a second mode of operation, and a stage indicator for indicating a plurality of adjustable stages for the first mode of operation, with the following steps:

Activating the first and/or the second mode of operation, wherein the first mode of operation is activated by actuating the first control element, and the second mode of operation is activated by actuating the second control element,

Adjusting a stage for the first mode of operation, wherein adjusting the stage is performed after activation of the first mode of operation and by re-actuating the first control element, wherein an adjusted stage for the first mode of operation is indicated via the stage indicator.

Deactivating the first and/or the second mode of operation, wherein the first mode of operation is deactivated by actuating the first control element, and the second mode of operation is deactivated by actuating the second control element.

Thus, the technical advantage can be achieved of providing an improved method for operating a hand-held power tool. Using the proposed method, the user is able to immediately and clearly set both the desired modes of operation and their specific stage adjustment. In particular, the multiple functionality of the first control element—on the one hand for activating or deactivating the mode of operation and, on the other hand, for adjusting the stage by re-actuating —results in a reduction of the required control elements and thus a compact, manageable, and user-friendly design of the HMI. Displaying the set stages using the associated stage indicator also provides the user with clear visual feedback about the current setting, avoiding incorrect operation and increasing precision and safety when using the hand-held power tool.

In another embodiment, activating and deactivating the first and/or second mode of operation is performed by actuating the respective associated control element for a defined period of time.

This can achieve the technical advantage that activation and deactivation of the respective modes of operation can be ensured safely and easily. In particular, the actuation of the control elements for a defined period of time can reliably prevent accidental or unwanted function changes, which leads to increased operational safety. At the same time, the method allows a reduction of the required control elements, since a single control element can take over several functions by linking different operating actions (short or longer actuation) with clearly distinguishable functional states.

In another embodiment, adjusting the stages for the first mode of operation is performed by actuating the first control element multiple times within a specified period of time.

This can achieve the technical advantage that the user can intuitively adjust the desired stage of the first mode of operation. The multiple actuation of the first control element within a defined time period allows for quick, straightforward, and precise adjustment without the need for separate control elements or complex operating actions. This can reduce the scope of the user interface on the one hand and effectively avoid incorrect operation on the other hand.

In another embodiment, a third mode of operation is activated and deactivated by actuating the first and second control elements, wherein activating and deactivating the third mode of operation is performed by simultaneously actuating the first and second control elements for a defined period of time.

This can achieve the technical advantage that activation of a third mode of operation can be performed clearly and intuitively. Simultaneous actuation of the first and second control elements for a defined period of time ensures that accidental or unintended activation of this additional mode of operation is reliably avoided. At the same time, there is no need for an additional, separate control element, which contributes to a more compact and manageable design of the HMI.

### BRIEF DESCRIPTION OF THE DRAWINGS

The disclosure is explained in more detail below with reference to exemplary embodiments. Shown are:

FIG. 1 a hand-held power tool and a human-machine interface in a first exemplary embodiment,

FIG. 2 a hand-held power tool and an HMI in another exemplary embodiment,

FIG. 3 a hand-held power tool and an HMI in another embodiment,

FIG. 4 a hand-held power tool and an HMI in another exemplary embodiment,

FIG. 5 a schematic illustration of a method for operating a hand-held power tool,

FIG. 6 a hand-held power tool and an HMI in another embodiment,

FIG. 7 a hand-held power tool and an HMI in another embodiment,

FIG. 8 a schematic illustration of a method for operating a hand-held power tool,

FIG. 9 a hand-held power tool and an HMI in another embodiment,

FIG. 10 a hand-held power tool and an HMI in another embodiment, and

FIG. 11 a hand-held power tool and an HMI in another embodiment.

It is pointed out that the figures are schematic in nature and not to scale. In this sense, components shown in the figures may be shown exaggeratedly large or small for better understanding.

### DETAILED DESCRIPTION

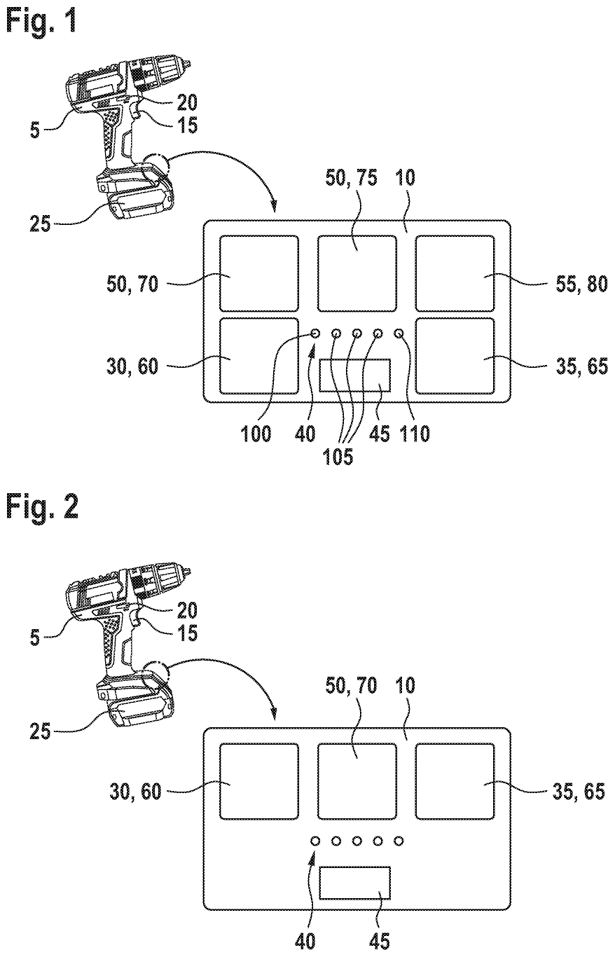

FIG. 1 shows an exemplary hand-held power tool 5 and a human-machine interface (HMI 10) in a first exemplary embodiment.

The hand-held power tool 5 is configured, by way of example, as an impact wrench or a rotary impact wrench. The hand-held power tool 5 may also be any other hand-held power tool, for example an angle screwdriver. In the exemplary embodiment of an impact wrench or a rotary impact wrench, the hand-held power tool 5 comprises a trigger 15 a direction-of-rotation switch 20 and a gear switch not shown. The trigger 15 is provided to initiate operation of the hand-held power tool 5. The rotary switch 20 is provided to set a direction of rotation of the hand-held power tool 5.

The hand-held power tool 5 comprises the HMI 10. The HMI 10 is arranged, by way of example, in an area above a power supply source 25 provided for operation of the hand-held power tool 5. The power supply source 25 is designed as a battery or rechargeable battery pack, for example. However, the hand-held power tool 5 can also be connected to a power supply network in order to be operated.

The hand-held power tool 5 is operable in at least a first mode of operation and/or a second mode of operation. The first mode of operation is thereby activatable, adjustable through a plurality of stages, and deactivatable. The second mode of operation is activatable and deactivatable.

Generally, a mode of operation may be understood to mean a specific device setting or function of the hand-held power tool 5, whereby the manner of operation of the hand-held power tool 5 can be specified. For example, a mode of operation may serve to adapt the hand-held power tool 5 to different requirements and working conditions. For example, different modes of operation can be used to set different speeds, power levels, or safety mechanisms to increase efficiency, precision, and ease of use.

The first mode of operation and the second mode of operation differ in that the first mode of operation, in addition to being activated and deactivated, is adjustable through a plurality of stages.

For example, a speed setting for a rotational speed, an auto-shut-off function, an auto-slow-down function, an ABR function, a shut-off-after-time function, or a light intensity regulation can be viewed as the first mode of operation. For example, a second mode of operation may be considered a function such as worksite lighting on/off, free-socket mode on/off, or soft-start on/off.

The HMI 10 is used by a user to set different modes of operation for the hand-held power tool 5. The HMI 10 comprises at least a first control element 30 for the first mode of operation and a second control element 35 for the second mode of operation. The first mode of operation is activatable, adjustable, and deactivatable using the first control element 30. The second mode of operation is activatable and deactivatable using the second control element 35.

For example, the control elements 30, 35 may be configured in the form of buttons 60, 65. It is also conceivable that the control elements 30, 35 are integrated in the HMI 10, for example in the form of a touch display.

In this embodiment, the HMI 10 comprises the first control element 30 in the form of a first button 60 and the second control element 35 in the form of a second button 65. Using the first control element 30 or the first button 60, respectively, the first mode of operation for the hand-held power tool 5 can be activated, adjusted, and deactivated. For example, the first mode of operation may be a speed setting for the rotational speed of the hand-held power tool 5. Using the second control element 35 or the second button 65, respectively, the second mode of operation for the hand-held power tool 5 can be activated and deactivated. For example, the second mode of operation may be the free-socket mode on/off function. Activating, adjusting, and deactivating the first mode of operation is possible, for example, by actuating the first button 60. Activating and deactivating the second mode of operation is possible, for example, by actuating the second button 65.

In this embodiment, for example, by actuating the first button 60, the first mode of operation for setting the rotational speed can be adjusted in multiple stages. For example, the speed setting for the rotational speed of the hand-held power tool 5 may be adjustable between 1,000 revolutions per minute as the lowest setting and 3,000 revolutions per minute as the highest setting.

The HMI 10 comprises a stage indicator 40 for indicating the plurality of adjustable stages for the first mode of operation. A currently set stage for the first mode of operation may be displayed using the stage indicator 40.

By way of example, the stage indicator 40 is shown in the form of illuminated elements, in particular as an LED bar. For example, the illuminated elements are simple point LEDs arranged on the HMI 10. By way of example, five point LEDs in the form of an LED bar are shown as a stage indicator 40. Thus, in the present embodiment, five different stages for a first mode of operation may be displayed via the stage indicator 40. For example, a first stage 100 may be indicated by a first LED lighting up and a final stage 110 by all five LEDs lighting up. For a second, third, and fourth stage, three intermediate stages 105 in the form of three point LEDs are provided. For example, a speed of 1,000 revolutions per minute may be considered as the first stage 100, and a speed of 3,000 revolutions per minute may be considered as the final stage 110. The intermediate stages 105, respectively the second, third, and fourth stages, are preferably divided in a linearly ascending fashion between the first stage 100 and the final stage 110. For this exemplary embodiment, therefore, settings of 1,500 revolutions per minute for the second stage, 2,000 revolutions per minute for the third stage, and 2,500 revolutions per minute for the fourth stage would be provided.

The HMI 10 can additionally comprise two further first control elements 50. For example, the two further first control elements 50 may be provided in the form of a third button 70 and a fourth button 75. For example, two additional and different further first modes of operation may be activated, adjusted, and deactivated using the two further first control elements 50. For example, using the third button 70, auto shut-off may be activated, adjusted, and deactivated as a further first mode of operation. For example, using the fourth button 75, auto shut-off after time may be activated, adjusted, and deactivated as a further first mode of operation. The stage indicator 40 is also usable to display the plurality of stages of the further first modes of operation.

Additionally, a further second control element 55 may be provided in the form of a fifth button 80 for a further second mode of operation. The further second mode of operation may be, for example, worksite lighting on/off. For example, the HMI 10 has worksite lighting 45 for this purpose. The worksite lighting 45 may be activated and deactivated by actuating the fifth button 80.

Additionally, the first control element 30 and/or the second control element 35 and/or the further first and second control elements 50, 55 may also be configured as display elements. For example, it is conceivable that control elements 30, 35, 50, 55, or buttons 60, 65, 70, 75, 80, respectively, will be illuminated upon activation of an associated mode of operation. This advantageously signals to a user via the HMI 10, which mode of operation the hand-held power tool 5 is in.

In one embodiment, after activation of the first mode of operation, a last-used stage of the selected and activated mode of operation can be displayed by the stage indicator 40.

It is also conceivable that the first mode of operation and/or the second mode of operation can be activated and deactivated by actuating the respective associated controls 30, 35, 50, 55 for a defined period of time. Thus, it may be provided that, to activate the first mode of operation via the first control element 30, the first control element 30 is actuated for one, two or three seconds. To deactivate the first mode of operation via the first control element 30, it may also be provided to actuate the first control element 30 for one, two or three seconds. This may be provided analogously for all provided first and second modes of operation and associated control elements 30, 35, 50, 55. This can prevent unintended activation or deactivation of the modes of operation, for example due to accidental actuation of a control element 30, 35, 50, 55.

Alternatively or additionally, it may be provided that a defined period of time is provided between activating a mode of operation and deactivating the same mode of operation. For example, after activation of the first mode of operation via the first control element 30, it may be deactivatable again via the first control element 30 after two, four or five seconds.

For adjusting the plurality of stages of the first mode of operation or a further first mode of operation, it is conceivable that, after activation, the first mode of operation is adjustable through the different stages by re-actuating the first control element 30, 50 within a specifiable period of time, in particular by repeatedly actuating the control element 30, 50 within a specifiable period of time. For example, it may be provided that the first control element 30 is actuated multiple times within one second after activation of the first mode of operation to adjust the stage of the first mode of operation.

Alternatively, it may be provided that, for adjusting the first mode of operation or a further first mode of operation after activation, the first mode of operation is adjustable through the different stages by re-actuating the first control element 30, 50, in particular by means of sustained single actuation of the first control element 30, 50. For example, after activation and by means of sustained re-actuation of the first button 60, the stage indicator 40 can be cycled through. Upon reaching the final stage 110 of the stage indicator 40 and with continued actuation of the first button 60, the stage indicator 40 returns to the first stage 100. When a desired stage to be set is reached, it is set by releasing the first control element 30 or the first button 60, respectively.

Furthermore, it may be provided that a further first mode of operation is activated by actuating a further first control element 50. In this case, if a further first mode of operation is activated, the other first mode of operation is automatically deactivated.

Alternatively or additionally, by actuating a second control element 35, a second mode of operation can be additionally switched on in addition to one of the first modes of operation. For example, by actuating the fifth button 80, worksite lighting 45 can be turned on or off, while one of the first modes of operation remains activated. For example, it is possible to operate the hand-held power tool 5 simultaneously in a first mode of operation and a second mode of operation.

A third mode of operation may also be activatable and deactivatable using the HMI 10. The third mode of operation may be, for example, an auxiliary function for the HMI 10 or the hand-held power tool 5. For example, the third mode of operation may be the HMI lock function, i.e., locking the HMI 10, or the factory reset function, i.e., resetting to factory settings.

The third mode of operation may be activatable, for example, by simultaneously actuating the first control element 30 and the second control element 35. For example, by simultaneously actuating the first control element 30 and the second control element 35 for, for example, three seconds, the HMI lock function may be activated as the third mode of operation. By re-actuating the first control element 30 and the second control element 35 simultaneously for three seconds, the HMI lock function is deactivatable.

The activated HMI lock function may be displayed to the user by the stage indicator 40, when a control element 30, 35, 50, 55 is actuated, pulsing continuously for, for example, 2 seconds.

It may also be provided that, for example, by actuating the further first control element 50 and the further second control element 55, the HMI 10 is set to factory reset.

Activation of the factory reset may be signaled to the user by the fact that, for example, all control elements 30, 35, 50, 55 on the HMI 10 illuminate for a defined period of time, for example one second.

FIG. 2 schematically illustrates a hand-held power tool 5 and an HMI 10 in another exemplary embodiment.

The hand-held power tool 5 and the HMI 10 substantially correspond to the hand-held power tool and the HMI of FIG. 1. For example, the hand-held power tool 5 can again be configured in the form of an impact wrench or a rotary impact wrench. The hand-held power tool 5 again comprises a trigger 15, a direction-of-rotation switch 20, and a power supply source 25. The HMI 10 is again arranged in an area above the power supply source 25.

The hand-held power tool 5 is again operable in at least a first mode of operation and/or in a second mode of operation. The HMI 10 comprises a first control element 30 for the first mode of operation and a second control element 35 for the second mode of operation. Furthermore, by way of example, a further first control element 50 is provided for a further first mode of operation. For example, the first control elements 30, 50 and the second control element 35 may again be in the form of a first button 60, a second button 65 and a third button 70. The first modes of operation are again activatable, adjustable through a plurality of stages, and deactivatable. The second mode of operation is activatable and deactivatable. The HMI 10 again comprises a stage indicator 40 for indicating the plurality of adjustable stages for the first modes of operation. Furthermore, the HMI 10 includes, for example, worksite lighting 45.

The first mode of operation is activatable, adjustable, and deactivatable using the first control element 30. The second mode of operation is activatable and deactivatable using the second control element 35. A further first mode of operation is activatable, adjustable, and deactivatable using the further first control element 50.

For example, the stage indicator 40 is again configured in the form of illuminated point LEDs. By way of example, the stage indicator 40 is configured in the form of five point LEDs as an LED bar. Thus, using the present HMI 10, five different stage adjustments for the first modes of operation can be displayed using the stage indicator 40. The statements from FIG. 1 apply analogously to the display options of the stage indicator 40.

Activating, adjusting, and deactivating the first modes of operation using the first control elements 30, 50 may be performed analogously to the possibilities already discussed with respect to FIG. 1.

The worksite lighting 45 is activatable and deactivatable as a second mode of operation using the second control element 35.

Activating and deactivating the second mode of operation using the second control element 35 may be performed analogously to the possibilities already discussed with respect to FIG. 1.

A third mode of operation can also be activated and deactivated using the HMI 10, wherein the possibilities already discussed with respect to FIG. 1 can be performed for a third mode of operation.

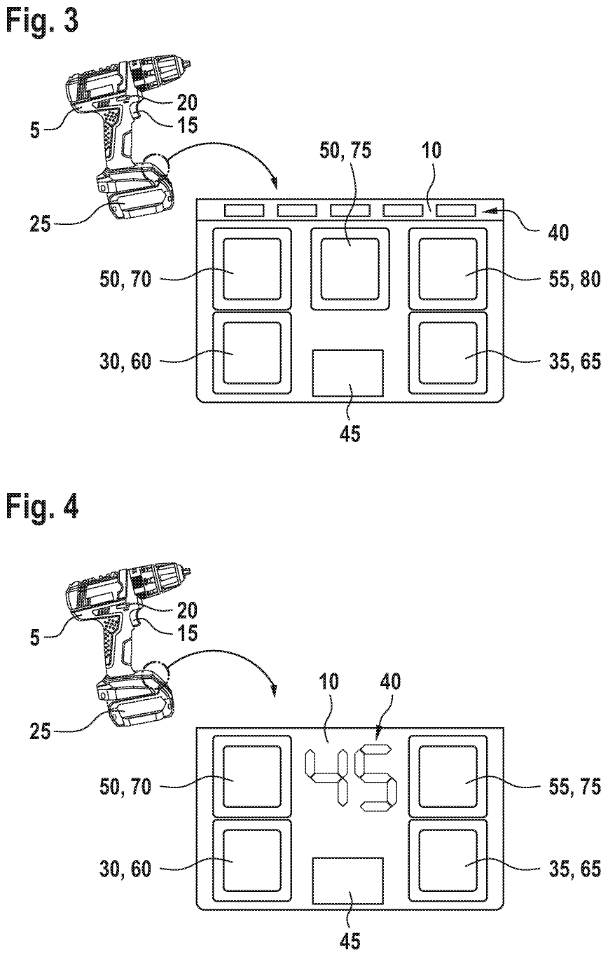

FIG. 3 shows a hand-held power tool 5 and an HMI 10 in another embodiment.

The hand-held power tool 5 and the HMI 10 are substantially similar to the hand-held power tool and the HMI of FIG. 1. For example, the hand-held power tool 5 can again be provided in the form of an impact wrench or a rotary impact wrench. The hand-held power tool 5 again comprises a trigger 15, a direction-of-rotation switch 20, and a power supply source 25.

The HMI 10 is again arranged above the power supply source 25 of the hand power tool 5.

The hand-held power tool 5 is operable in at least a first mode of operation and/or a second mode of operation. The HMI 10 comprises a stage indicator 40, a first control element 30, and a second control element 35. The first control element 30 is provided for the first mode of operation, and the second control element 35 is provided for the second mode of operation. The first mode of operation is activatable, adjustable through a plurality of stages, and deactivatable. The second mode of operation is activatable and deactivatable. The first mode of operation is activatable, adjustable, and deactivatable using the first control element 30. The second mode of operation is activatable and deactivatable using the second control element 35. Furthermore, the hand-held power tool 5 may be operable in a third mode of operation.

The HMI 10 again comprises two further first control elements 50 for two further first modes of operation and a further second control element 55 for a further second mode of operation. Furthermore, exemplary worksite lighting 45 is provided.

Activating, adjusting, and deactivating the various modes of operation using the control elements 30, 35, 50, 55 may be performed analogously to the configurations of FIG. 1. To avoid repetition, only the differences from the embodiment shown in FIG. 1 will be discussed below.

In this embodiment, unlike in FIG. 1 and FIG. 2, the stage indicator 40 is not provided as an LED bar with illuminable point LEDs, but rather as an LED bar with illuminable rectangular LEDs. For example, five illuminable rectangular LEDs are provided.

FIG. 4 shows a hand-held power tool 5 and an HMI 10 in another exemplary embodiment.

The hand-held power tool 5 and the HMI 10 again substantially correspond to the HMI and the hand-held power tool of FIG. 1.

The hand-held power tool 5 comprises a trigger 15, a direction-of-rotation switch 20, and a power supply source 25. For example, the HMI 10 is again arranged in an area above the power supply source 25.

The hand-held power tool 5 is operable in at least a first mode of operation and/or a second mode of operation. The HMI 10 comprises a first control element 30 and a second control element 35. The first mode of operation is activatable, adjustable through a plurality of stages, and deactivatable using the first control element 30. The second mode of operation is activatable and deactivatable using the second control element 35. For example, the first control element 30 and the second control element 35 are in the form of a first button 60 and a second button 65. The HMI 10 further comprises a stage indicator 40 for indicating a plurality of adjustable stages for the first mode of operation.

For example, a further first control element 50 in the form of a third button 70 and a further second control element 55 in the form of a fourth button 75 are provided. The further first control element 50 is for activating, adjusting, and deactivating a further first mode of operation. The further second control element 55 is for activating and deactivating a further second mode of operation. The hand-held power tool 5 may also be operable in a third mode of operation.

Activating, adjusting, and deactivating the various modes of operation using the control elements 30, 35, 50, 55 may be performed analogously to the configurations of FIG. 1. To avoid repetition, only the differences from the embodiment shown in FIG. 1 will be discussed below.

In contrast to FIG. 1, the stage indicator 40 of the HMI 10 is configured as a 7-segment display. By way of example, as a two-digit 7-segment display.

Using the 7-segment displays, a plurality of adjustable stages for one of the first modes of operation may be displayed. For example, it is possible to display stages 0 to 99 via the two-digit 7-segment display. Adjustment of the stages may be similar to FIG. 1 after activation of the first mode of operation and by re-actuating a respective associated first control element 30, 50.

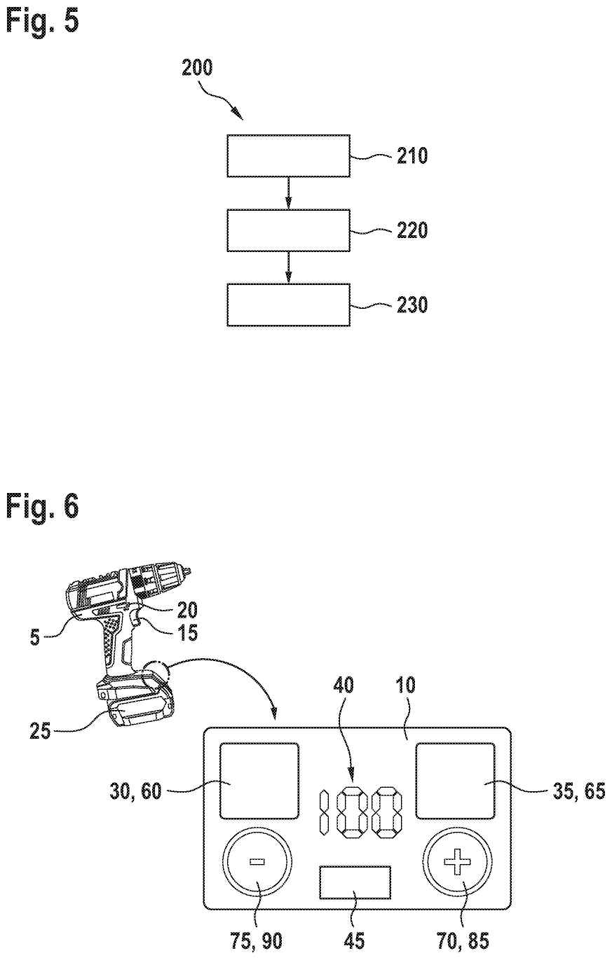

FIG. 5 schematically illustrates a method 200 of operating a hand-held power tool.

The method 200 serves to operate a hand-held power tool.

The hand-held power tool comprises an HMI for operation by a user, wherein the HMI comprises at least a first control element for a first mode of operation, a second control element for a second mode of operation, and a stage indicator for indicating a plurality of adjustable stages for the first mode of operation.

The method 200 also includes the following steps:

In a first method step 210, the first and/or the second mode of operation is activated, wherein the first mode of operation is activated by actuating the first control element, and the second mode of operation is activated by actuating the second control element.

For activating 210 the first and/or the second mode of operation, it may additionally be provided that actuation of the respective associated control element is performed for a defined period of time. For example, activation may be performed by actuating the respective associated control element for one or two seconds.

Additionally, it may also be provided that a third mode of operation is activated. Activating the third mode of operation is performed by simultaneously actuating the first control element and the second control element for a defined period of time. For example, simultaneous actuation of the first and second control elements for one or two seconds may be provided for activation of the third mode of operation.

In a second method step 220, a stage is adjusted for the first mode of operation, wherein adjusting the stage is performed after activation of the first mode of operation and by re-actuating the first control element, wherein an adjusted stage for the first mode of operation is indicated via the stage indicator.

For adjusting 220 the stages, it may be provided that the stage is adjusted by actuating the first control element multiple times within a specifiable period of time.

In a third method step 230, the first and/or the second mode of operation is deactivated, wherein the first mode of operation is deactivated by actuating the first control element, and the second mode of operation is deactivated by actuating the second control element.

For deactivating 230 the first and/or the second mode of operation, it may additionally be provided that actuation of the respective associated control element is performed for a defined period of time. For example, deactivation may be performed by actuating the respective associated control element for one or two seconds.

Additionally, it may also be provided that a third mode of operation is deactivated. Deactivating the third mode of operation is performed by simultaneously actuating the first control element and the second control element for a defined period of time. For example, simultaneous actuation of the first and second control elements for one or two seconds may be performed for deactivation of the third mode of operation.

The described method 200 may, in particular, be used to operate a hand-held power tool as shown in FIGS. 1 to 4.

FIG. 6 shows a hand-held power tool 5 and an HMI 10 in another embodiment.

For example, the hand-held power tool 5 comprises a trigger 15, a direction-of-rotation switch 20, and a power supply source 25. For example, the HMI 10 is again arranged above a power supply source 25 on the hand-held power tool 5.

The hand-held power tool 5 is operable in at least a first mode of operation and/or a second mode of operation. The HMI 10 comprises a first control element 30 and a third control element 85 for the first mode of operation. Furthermore, the HMI 10 comprises a second control element 35 for the second mode of operation. For example, the first control element 30 may be provided in the form of a first button 60. For example, the second control element 35 may be provided in the form of a second button 65. For example, the third control element 85 may be provided in the form of a third button 70.

The first mode of operation is again activatable, adjustable through a plurality of stages, and deactivatable. The first mode of operation is activatable and deactivatable using the first control element 30 and adjustable through a plurality of stages using the third control element 85. The second mode of operation is activatable and deactivatable using the second control element 35.

The HMI 10 further comprises a stage indicator 40 for indicating the plurality of adjustable stages for the first mode of operation. For example, the stage indicator 40 is in the form of a three-digit 7-segment display.

In this embodiment, for example, an electronic angular setting may be activatable and adjustable as the first mode of operation using the HMI 10. The electronic angular setting may be activatable by actuating the first control element 30. The first mode of operation may be adjustable through a plurality of stages using the third control element 85. By way of example, a further third control element 90 is provided for adjusting the stages of the first mode of operation. The further third control element 90 is configured, for example, in the form of a fourth button 75. Using the third control element 85 and the further third control element 90, the stage setting for the first mode of operation can be adjusted after activation. For example, by using the third control element 85, the stage may be shifted upward and, by using the further third control element 90, the stage may be shifted downward. Upward and downward shifting of the various stages using the third control element 85 and the further third control element 90 is accomplished, for example, by simply pressing the buttons 70, 75.

In this embodiment, workplace lighting 45 is additionally provided. The workplace lighting 45 may be activated and deactivated by using the second control element 35. Activating and deactivating the workplace lighting 45 may be performed, for example, by pressing the second button 65.

In other words, in this embodiment, a first control element 30 for activating or deactivating a first mode of operation is provided, wherein adjusting the different stages for the first mode of operation is possible using a third control element 85 and optionally a further third control element 90. A second mode of operation may be activated or deactivated using a second control element 35. In this embodiment, it is consequently possible to switch on or switch off workplace lighting 45 using the second control element 35.

Additionally, the first control element 30 and the second control element 35 may also be configured as display elements. The controls 30, 35 are configured for this purpose, for example, as illuminable buttons 60, 65. When an associated mode of operation is activated, illumination of the buttons 60, 65 indicates that the associated mode of operation is activated.

Furthermore, it is also conceivable to activate and deactivate a third mode of operation using the HMI 10 for the hand-held power tool 5.

The third mode of operation may be activatable, for example, by simultaneously actuating the first control element 30 and the second control element 35. For example, HMI lock may be activated as the third mode of operation by simultaneously actuating the first control element 30 and the second control element 35 for three seconds. By re-actuating the first control element 30 and the second control element 35 simultaneously for three seconds, the HMI lock function is deactivatable.

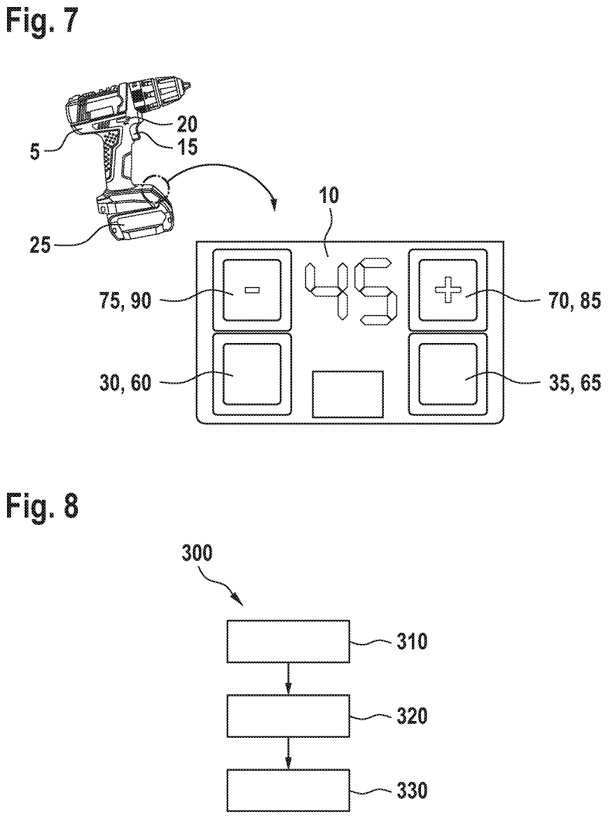

FIG. 7 shows a hand-held power tool 5 and an HMI 10 in another embodiment.

The hand-held power tool 5 and the HMI 10 substantially correspond to the hand-held power tool 5 and the HMI 10 of FIG. 6.

For example, the hand-held power tool 5 comprises a trigger 15, a direction-of-rotation switch 20, and a power supply source 25. The HMI 10 is again arranged above the power supply source 25 on the hand-held power tool 5.

The HMI 10 comprises a first control element 30, a third control element 85, a further third control element 90, and a second control element 35. For example, the control elements 30, 35, 85, 90 may be configured in the form of buttons 60, 65, 70, 75.

The hand-held power tool 5 is again operable in at least a first mode of operation and a second mode of operation. Additionally, it may be provided that the hand-held power tool is operable in a third mode of operation.

The statements of FIG. 6 apply analogously to the activation and deactivation of the modes of operation. The statements of FIG. 6 apply equally to adjusting the first mode of operation. To avoid repetition, only the differences from the hand-held power tool 5 of FIG. 6 are discussed.

In this embodiment, the hand-held power tool 5 has a two-digit 7-segment display as a stage indicator 40 on the HMI 10. The hand-held power tool 5 may also include an LED bar on the HMI 10 as a stage indicator 40.

FIG. 8 schematically illustrates a method 300 for operating a hand-held power tool.

The method 300 serves to operate a hand-held power tool.

The power tool comprises an HMI for operation by a user, wherein the HMI comprises a first control element and a third control element for a first mode of operation and a second control element for a second mode of operation, wherein the HMI comprises a stage indicator for indicating a plurality of adjustable stages for the first mode of operation.

The method 300 also includes the following steps:

In a first method step 310, the first and/or second mode of operation is activated, wherein the first mode of operation is activated by actuating the first control element, and the second mode of operation is activated by actuating the second control element.

For activating 310 the first and/or the second mode of operation, it may additionally be provided that actuation of the respective associated control element is performed for a defined period of time. For example, activation may be performed by actuating the respective associated control element for one or two seconds.

Additionally, it may also be provided that a third mode of operation is activated. Activating the third mode of operation is performed by simultaneously actuating the first control element and the second control element for a defined period of time. For example, simultaneous actuation of the first and second control elements for one or two seconds may be provided for activation of the third mode of operation.

In a second method step 320, a stage is adjusted for the first mode of operation, wherein adjusting the stage is performed after activation of the first mode of operation and by actuating the third control element, wherein an adjusted stage for the first mode of operation is indicated via the stage indicator.

For adjusting 320 the stages, multiple actuations and/or a sustained actuation of the third control element may be performed within a specifiable time period.

The HMI may comprise a further third control element. Adjusting 320 the stage for the first mode of operation may be performed using the third control element and the further third control element. For example, by using the third control element, the stage may be increased and, by using the further third control element, the stage may be decreased.

In a third method step 330, the first and/or second mode of operation is deactivated, wherein the first mode of operation is deactivated by actuating the first control element, and the second mode of operation is deactivated by actuating the second control element.

For deactivating 330 the first and/or the second mode of operation, it may additionally be provided that actuation of the respective associated control element is performed for a defined period of time. For example, deactivation may be performed by actuating the respective associated control element for one or two seconds.

Additionally, it may also be provided that a third mode of operation is deactivated. Deactivating the third mode of operation is performed by simultaneously actuating the first control element and the second control element for a defined period of time. For example, simultaneous actuation of the first and second control elements for one or two seconds may be performed for deactivation of the third mode of operation.

The described method 300 may, in particular, be used to operate a hand-held power tool as shown in FIGS. 6 and 7.

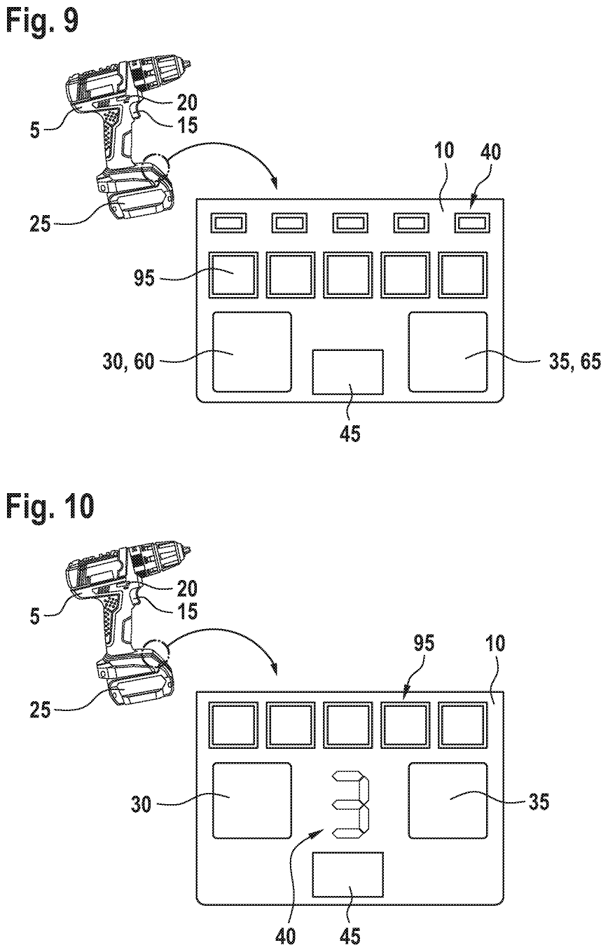

FIG. 9 shows a hand-held power tool 5 and an HMI 10 in another embodiment.

The hand-held power tool 5 may be configured, by way of example, as an impact wrench or as a rotary impact wrench. The hand-held power tool 5 may comprise a direction-of-rotation switch 20, a trigger 15, and a power supply source 25. For example, the HMI 10 is arranged on the hand-held power tool 5 in an area above the power supply source 25.

In this embodiment, the HMI 10 comprises a first control element 30 and a second control element 35. For example, the first control element 30 is configured as a first button 60. For example, the second control element 35 is configured as a second button 65. The HMI 10 further comprises a mode of operation indicator 95. The power tool 5 is operable in at least a first and/or a second mode of operation. The mode of operation indicator 95 is used to indicate which of the modes of operation is currently activated for the hand-held power tool 5, and which modes of operation can be activated. In this example, the mode of operation indicator 95 has six display options for different first and/or second modes of operation.

A first mode of operation is again characterized by being adjustable through a plurality of stages. For this purpose, the HMI 10 comprises a stage indicator 40 for indicating the plurality of stages. In this exemplary embodiment, the stage indicator 40 is configured as an illuminable LED bar. By way of example, five illuminable rectangular LED elements are arranged on the HMI 10.

In contrast to the preceding embodiments, the first control element 30 is used to select a mode of operation via the mode of operation indicator 95. Thus, by actuating the first control element 30 multiple times, it is possible to cycle through the different modes of operation of the mode of operation indicator 95. The second control element 35 may be used to activate the previously selected mode of operation.

If the activated mode of operation is a second mode of operation, then the hand-held power tool may be operated in the second mode of operation after activation. For example, the worksite lighting 45 on function may be activated as the second mode of operation.

In the event that the activated mode of operation is a first mode of operation, the stage indicator 40 is first activated. The various stages may then be cycled through using the first control element 30. The second control element 35 can then be used to accept the selected stage for the first mode of operation. After the selection and adjustment of the first mode of operation have been performed, the hand-held power tool may be operated in the selected mode.

In other words, in this embodiment, the first control element 30 acts as a type of selection element, and the second control element 35 acts as a type of confirmation element.

Thus, with the first control element 30, a selection for a mode of operation and/or a stage adjustment may be made, and with the second control element 35, the previously made selection of the mode of operation and/or the stage selection may be confirmed.

Furthermore, it is again conceivable that the hand-held power tool machine 5 is operable in a third mode of operation.

The third mode of operation may be activatable, for example, by simultaneously actuating the first control element 30 and the second control element 35. For example, HMI lock may be activated as the third mode of operation by simultaneously actuating the first control element 30 and the second control element 35 for three seconds. By re-actuating the first control element 30 and the second control element 35 simultaneously for three seconds, the HMI lock function is deactivatable.

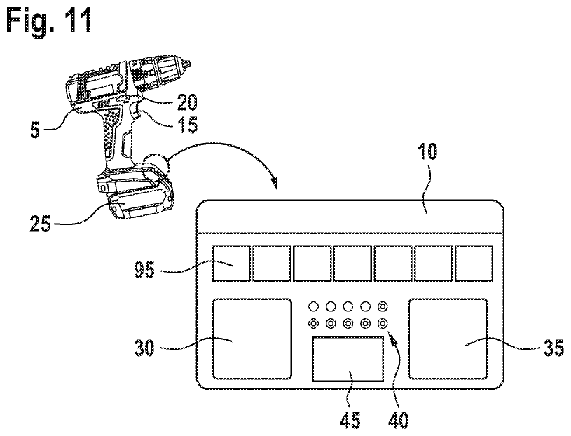

FIGS. 10 and 11 show a hand-held power tool 5 and an HMI 10 in further embodiments.

The hand-held power tools 5 and the HMIs 10 of FIGS. 10 and 11 substantially correspond to the embodiment of FIG. 9.

To avoid repetition, only the differences from the embodiment of FIG. 9 will be discussed below.

An essential difference for the embodiment of FIG. 10 is that the HMI 10 comprises a 7-segment display as the stage indicator 40. Using the 7-segment display, the adjustable stages for a first mode of operation can again be indicated.

An essential difference for the embodiment of FIG. 11 is that the HMI 10 comprises an LED bar with point LEDs as the stage indicator 40. Using the point LEDs, the adjustable stages for a first mode of operation can again be indicated. By way of example, ten point LEDs are provided for the adjustable stages of the hand-held power tool 10.

Although the disclosure has been described above on the basis of specific exemplary embodiments, the person skilled in the art can also realize embodiments that were not or only partially disclosed above, without departing from the core of the disclosure.

What is claimed is:

1. A hand-held power tool, comprising:
a human-machine interface (“HMI”) including (i) a first control element for a first mode of operation of the hand-held power tool, (ii) a second control element for a second mode of operation of the hand-held power tool, and (iii) a stage indicator,
wherein the first mode of operation is activatable, adjustable through a plurality of stages, and deactivatable using the first control element,
wherein the second mode of operation is activatable and deactivatable using the second control element, and
wherein the stage indicator is configured to display at least one stage of the plurality of stages for the first mode of operation.

2. The hand-held power tool according to claim 1, wherein:
activation and deactivation of the first mode of operation is performed by actuating the first control element for a first defined period of time, and
activation and deactivation of the second mode of operation is performed by actuating the second control element for a second defined period of time.

3. The hand-held power tool according to claim 1, wherein:
adjusting the plurality of stages for the first mode of operation is performed after activation of the first mode of operation by re-actuating the first control element, and
adjusting the plurality of stages is performed by actuating the first control element multiple times within a specified period of time.

4. The hand-held power tool according to claim 1, wherein:
the HMI further comprises a further first control element for a further first mode of operation of the hand-held power tool,
the further first mode of operation is activatable, adjustable through a plurality of further stages, and deactivatable using the further first control element, and
the stage indicator is configured to display (i) the at least one stage of the plurality of stages for the first mode of operation, and (ii) at least one further stage of the plurality of further stages for the further first mode of operation.

5. The hand-held power tool according to claim 1, wherein:
the HMI further comprises a further second control element for a further second mode of operation of the hand-held power tool, and
the further second mode of operation is activatable and deactivatable using the further second control element.

6. The hand-held power tool according to claim 1, wherein:
the first control element is configured as a first illuminable button for indicating when the first mode of operation is activated or deactivated, and
the second control element is configured as a second illuminable button for indicating when the second mode of operation is activated or deactivated.

7. The hand-held power tool according to claim 1, wherein the stage indicator is configured as an illuminable bar including a plurality of light emitting diodes.

8. The hand-held power tool according to claim 1, wherein the stage indicator is configured as a two-digit 7-segment display.

9. The hand-held power tool according to claim 1, wherein:
the HMI comprises worksite lighting,
the worksite lighting is the second mode of operation, and
the worksite lighting is activatable and deactivatable using the second control element.

10. The hand-held power tool according to claim 1, wherein:
the hand-held power tool is operable in a third mode of operation, and
the third mode of operation is activatable and deactivatable by simultaneously actuating the first control element and the second control element for a defined period of time.

11. A method for operating the hand-held power tool according to claim 1, the method comprising:
activating the first mode of operation by actuating the first control element and/or activating the second mode of operation by actuating the second control element;
adjusting a stage of the plurality of stages for the first mode of operation after activation of the first mode of operation and by re-actuating the first control element;
indicating the stage for the first mode of operation on the stage indicator; and
deactivating the first mode of operation by actuating the first control element and/or deactivating the second mode of operation by actuating the second control element.

12. The method according to claim 11, wherein:
activating and/or deactivating the first mode of operation by actuating the first control element for a first defined period of time, and
activating and/or deactivating the second mode of operation by actuating the second control element for a second defined period of time.

13. The method according to claim 11, wherein adjusting the stage for the first mode of operation is performed by actuating the first control element multiple times within a specified period of time.

14. The method according to claim 11, wherein:
activating a third mode of operation by simultaneously actuating the first control element and the second control element for a defined period of time, and
deactivating the third mode of operation by simultaneously actuating the first control element and the second control element for the defined period of time.
